(19) United States
(12) Patent Application Publication
(10) Pub. No.: US 2009/0072505 A1
(43) Pub. Date: Mar. 19, 2009

(54) Vehicle suspension with trailing arm and axle assembly and method

(75) Inventor: Kimmie McGinnis, Springfield, MO (US)

Correspondence Address: George Pappas, 919 S. Harrison Street, Suite 300, Fort Wayne, IN, 46802, US

(73) Assignee: Tuthill Corporation

(21) Appl. No.: 11/900,878

(22) Filed: Sep. 13, 2007

(51) Int. Cl. B60G 9/02

(52) U.S. Cl. 280/124.116

(57) ABSTRACT

A vehicle trailing arm suspension system wherein an axle is pivotally secured with trailing arms to a hanger bracket secured to the vehicle frame. Each of the trailing arms comprise a pivot arm component having a first end pivotally secured to the hanger bracket and a second end including a first axle engagement portion abutting the axle. The trailing arm further includes a tail component having a second axle engagement portion abutting the axle. The first and second axle engagement portions each include terminal ends which are located adjacent one another and are welded together such that the first and second axle engagement portions completely circumscribe the axle exterior surface. One of the axle engagement portions includes overlapping portions extending over the terminal ends of the other axle engagement portion. The trailing arm is thereby formed and secured to the axle by welding the pivot arm component and the tail component to one another in a position circumscribing the axle and, further, by welding the pivot arm component and/or the tail component to the axle. An air spring seat is affixed to the tail component. An air spring is located between the spring seat and the vehicle frame. A shock absorber bracket is affixed to the tail component. A shock absorber is pivotally secured between the shock absorber bracket and the vehicle frame.

### FIELD OF THE INVENTION

The present invention relates to vehicle suspension systems and, more particularly, a vehicle suspension system wherein an axle rotatably carrying ground engaging wheels is pivotally secured to a vehicle frame with trailing arms. Yet more particularly, the present invention is directed to an improved trailing arm and axle assembly and method of securing the trailing arm to an axle.

### BACKGROUND OF THE INVENTION

Trailing arm suspension systems are today commonly used on various vehicles including, for example, heavy duty trucks, semi trucks, trailers, etc. Typically, a driven or a non-driven axle is secured to the vehicle frame with a pair of trailing arms. The trailing arms extend longitudinally under the vehicle frame and, at one end, are rigidly or otherwise secured to the axle. At their other ends, the trailing arms are pivotally secured to the vehicle frame. Typically, the trailing arms are pivotally secured to a hanger bracket which, is in turn, affixed to the vehicle frame. Springs which can be coil springs and/or air springs, are provided between the vehicle frame and the trailing arms or axle whereby the vehicle weight may be transferred therethrough and to the axle and wheels. Shock absorbers are also typically provided between the vehicle frame and the trailing arms and/or the axle.

Many different trailing arms and attachment methods for attaching the trailing arms to the axle have been devised and are currently in use. For example, Schlosser et al, U.S. Pat. No. 6,557,875 describes a trailing arm, also known as a control arm, constructed of metal components welded together to form the arm. The arm includes first and second members each of which are provided with a recess formed in the sidewalls of the first and second members. The first and second members are welded together and surround a majority of the axle whereat the sidewall edges forming the recesses are welded to the axle.

Chan et al, U.S. Pat. No. 7,178,816 describes a vehicle suspension trailing arm/beam also constructed of metal components welded to form the arm. An axle wrap constructed of two halves completely surround and are secured on an axle. The axle wrap is, in turn, received within circular recesses formed through the arm sidewalls whereat the axle wrap is welded to the sidewalls.

Moreover, Smith et al, U.S. Pat. No. 6,241,266 describes a trailing arm suspension wherein an axle wrap is provided around the axle and wherein the axle wrap is in tension for maintaining the axle in compression. The axle wrap is rigidly secured to the trailing arm and, thus, the trailing arm is essentially held in place by friction between the wrapper and the axle.

Although the prior known trailing arms adequately serve to pivotally secure an axle to a vehicle frame, there remain shortcomings in connection therewith, and a need exists for a trailing arm which is relatively inexpensive to manufacture and secure to an axle but wherein the trailing arm to axle assembly is capable of withstanding the relatively severe forces to which the vehicle suspension is exposed.

### SUMMARY OF THE INVENTION

The object of the present invention is to overcome the shortcomings of prior trailing arm suspension systems, and to provide a trailing arm suspension system wherein the trailing arm and axle assembly and method of securement of the trailing arm to the axle is relatively inexpensive, and wherein the trailing arm and axle securement or assembly are capable of withstanding the forces to which the vehicle suspension is exposed and wherein such assembly is long lasting.

In summary, the present invention is a vehicle trailing arm suspension wherein each trailing arm is constructed of a pivot arm component having a first end which is adapted to be pivotally secured to the vehicle frame, typically via a hanger bracket which is itself affixed to the vehicle frame and extends downwardly therefrom. At its other end the pivot arm component includes a first axle engagement portion or saddle which is shaped complementary to the outside surface of the axle and for abutting the exterior surface of the axle when placed adjacent thereto. Preferably, the first axle engagement portion is semicircular shaped and is adapted to circumscribe a circular axle less than 180° there around. Preferably, the pivot arm component is made of metal by casting and includes a central portion having an I-beam cross sectional shape. The axle engagement portion further has first and second terminal ends located at the ends of the arch forming the axle engagement portion of less than 180°.

The vehicle suspension trailing arm further includes a tail component having a second axle engagement or saddle portion having a shape complementary to the exterior surface of the axle and adapted to abut the axle exterior surface when placed adjacent thereto. Preferably, the second axle engagement portion is semicircular shaped having an arch of at least 180° for abutting the axle exterior surface. The second axle engagement portion further includes first and second terminal ends located at the ends of the 180° arch. Preferably, the tail component is made of metal by forming processes and/or welding, although it is contemplated that it could also be made by casting.

For securing the trailing arm to the axle, the first axle engagement portion of the pivot arm component and the second axle engagement portion of the tail component are placed in abutting relation to the axle with the first terminal ends of the first and second axle engagement portions adjacent one another, and the second terminal ends of the first and second axle engagement portions adjacent one another. Accordingly, the axle engagement portions together completely circumscribe the axle. The pivot arm component and the tail component are welded to one another and to the axle for thereby forming the trailing arm and securing the trailing arm and axle together. More particularly, this is accomplished by welding the first terminal ends to one another, the second terminal ends to one another and the first and/or second axle engagement portions to the axle.

Preferably, the tail component axle engagement portion is provided with overlapping portions or ears at its terminal ends which extend tangentially with respect to the axle exterior circular surface away from the arch of at least 180°, and over the terminal ends of the pivot arm component axle engagement portion. Preferably, for affixing the trailing arm to the axle, the terminal ends of the first axle engagement portion of the pivot arm component are welded directly to the axle. The second axle engagement portion of the tail component is then placed in abutting relation to the axle with the overlapping terminal ends thereof extending over the first and second terminal ends of the first axle engagement portion of the pivot arm component. In this position, the overlapping portions or ears of the second axle engagement portion are welded to the pivot arm component and thereby securing the tail component.

Preferably, both the first and second axle engagement portions are provided with openings defining opening edges which are located adjacent the axle surface when the axle engagement portions are placed in abutting relation to the axle. The opening edges are welded to the axle for further securing the pivot arm and the tail components to the axle. Additionally, the first and second axle engagement portions or saddles include arc edges at the perimeter edge forming the semicircular shaped surfaces, and the arc edges thereof are welded to the axle exterior surface for yet further securing the pivot arm component and the tail component to the axle and, hence, to each other.

Preferably, a spring seat or bracket is affixed to the tail component by welding and is adapted to receive an air spring thereon. The air spring is thereby located between the spring seat and the vehicle frame, typically with yet another spring seat or bracket affixed to the vehicle frame and located above the air spring. The spring seat can be “overslung” wherein it is essentially located above the axle axis of rotation, or “underslung” wherein it is essentially located below the axle axis of rotation. The spring seat can be further secured to the tail component with bracket webs extending generally perpendicular to the second axle engagement portion. Yet more preferably, a shock absorber bracket is also provided and is secured to the tail component by welding. Accordingly, a shock absorber may be provided and be pivotally secured to the shock absorber bracket at its one end, and to the vehicle frame at its other end.

As can be appreciated, a vehicle suspension of the present invention incorporates a pair of trailing arm assemblies as described hereinabove on both lateral sides of a vehicle frame thereby rigidly securing the ends of the axle to the trailing arms generally near the ground engaging wheels thereof, and pivotally securing the axle to the vehicle frame.

In one form thereof the present invention is directed to a vehicle suspension whereby ground engaging wheels are mounted to a vehicle frame. The vehicle suspension includes an axle adapted to rotatably carry ground engaging wheels. A pair of trailing arms pivotally secure the axle to the vehicle frame. Each of the trailing arms comprise a pivot arm component having a first end pivotally secured to the frame and a second end comprising a first axle engagement portion. The axle engagement portion includes first and second terminal ends. Each of the trailing arms further comprise a tail component having a second axle engagement portion. The second axle engagement portion includes first and second terminal ends. The first and second axle engagement portions abut and together circumscribe the axle. The first terminal ends of the first and second axle engagement portions are affixed to one another and the second terminal ends of the first and second axle engagement portions are affixed to one another. At least one of the first and second axle engagement portions is affixed to the axle. A spring is provided between each of the trailing arms and the vehicle frame.

In another form thereof, the present invention is directed to a vehicle suspension trailing arm for pivotally securing an axle to a vehicle frame. The trailing arm includes a pivot arm component having a first end adapted for pivotal securement to the vehicle frame and a second end including a first axle engagement portion. The first axle engagement portion includes first and second terminal ends. A tail component is provided having a second axle engagement portion. The second axle engagement portion includes first and second terminal ends. The first and second axle engagement portions are adapted to abut and together circumscribe the axle. The first terminal ends of the first and second axle engagement portions are affixed to one another and the second terminal ends of the first and second axle engagement portions are affixed to one another. The pivot arm component is made of metal by casting.

In yet another form thereof the present invention is directed to a method of securing an axle to a trailing arm in a vehicle suspension. The trailing arm includes a pivot arm component having a first end adapted for pivotal securement to the vehicle frame and a second end including a first axle engagement portion. The first axle engagement portion includes first and second terminal ends. The trailing arm includes a tail component having a second axle engagement portion. The second axle engagement portion includes first and second terminal ends. The first and second axle engagement portions are adapted to abut and together circumscribe the axle. The method of securing an axle to the trailing arm includes the steps of placing the first and second axle engagement portions in abutting relation to the axle with the first terminal ends of the first and second axle engagement portions adjacent one another and the second terminal ends of the first and second axle engagement portions adjacent one another whereby the axle engagement portions together circumscribe the axle. The method further comprises the step of welding the first terminal ends to one another, the second terminal ends to one another and at least one of the first and second axle engagement portions to the axle.

In yet another form thereof, the present invention is directed to a vehicle suspension trailing arm for pivotally securing an axle to a vehicle frame. The trailing arm includes a pivot arm component having a first end adapted for pivotal securement to the vehicle frame and a second end including a first axle engagement portion. The first axle engagement portion includes first and second terminal ends. A tail component is provided having a second axle engagement portion. The second axle engagement portion includes first and second terminal ends. The first and second axle engagement portions are adapted to abut and together circumscribe the axle. The first terminal ends of the first and second axle engagement portions are affixed to one another and the second terminal ends of the first and second axle engagement portions are affixed to one another. At least one of the first and second axle engagement portions is affixed to the axle.

### BRIEF DESCRIPTION OF THE DRAWINGS

The above mentioned and other features and objects of this invention, and the manner of obtaining them, will become more apparent and the invention itself will be better understood by reference to the following description of embodiments of the invention in conjunction with the accompanying drawings wherein:

FIG. 1 is a side elevation view of a vehicle suspension and trailing arm constructed in accordance with the principles of the present invention and mounted to a vehicle frame;

FIG. 2 is a perspective view of the vehicle suspension shown in FIG. 1;

FIG. 3 is a perspective view similar to FIG. 2, but wherein the spring seat is underslung;

FIG. 4 is a side elevation view of the vehicle suspension and trailing arm shown in FIG. 3, and shown mounted to a vehicle frame;

FIG. 5 is a perspective view of a pivot arm component and a tail component whereby a trailing arm may be constructed on an axle in accordance with the principles of the present invention;

FIG. 6 is another perspective view of the pivot arm and tail components shown in FIG. 5;

FIG. 7 is a perspective view of the pivot arm and tail components of FIG. 5 shown affixed to one another for thereby forming a trailing arm in accordance with the principles of the present invention but wherein an axle is not shown therebetween; and,

FIG. 8 is a side elevation view of the trailing arm shown in FIG. 7 and depicting an axle circumscribed and affixed between the pivot arm and tail components forming the trailing arm in accordance with the principles of the present invention.

Corresponding reference characters indicate corresponding parts throughout these several views. Although the exemplification set out herein illustrate preferred embodiments of the invention, the embodiments disclosed herein are not intended to be exhaustive or to be construed as limiting the scope of the invention to the precise embodiments or forms disclosed.

### DETAILED DESCRIPTION OF THE PREFERRED EMBODIMENT

A trailing arm suspension system constructed in accordance with the principles of the present invention is shown and designated in the drawings by the numeral 10. The suspension system 10 includes a non-driven axle 12, although it is contemplated that driven axles could also be used therewith. Axle 12 includes spindle ends 14 for mounting ground engaging wheels thereon in a known and customary manner. A pair of trailing arms 16 are rigidly secured to the axle 12 at their rearward ends 18, and are pivotally secured at their forward ends 20 to a hanger bracket 22. Hanger bracket 22 is secured to a vehicle frame 24 and extends downwardly therefrom. Preferably, the pivot bolt 26 which pivotally secures the trailing arm 16 to the hanger bracket is selectively longitudinally adjustable such as with a mechanism 28 for thereby selectively adjusting the position of axle 12 relative to the vehicle frame 24 and, more particularly, for adjusting the axle 12 so as to be perpendicular to the longitudinal axis or direction of travel of the vehicle frame 24.

A spring seat generally designated by the numeral 30, is affixed to the rearward end 18 of each of the trailing arms 16 and is adapted to carry an air spring 32 thereon, although it is contemplated that a coil spring could also be used instead and/or in conjunction therewith. Spring 32 is located below the vehicle frame/chassis 24 and bears against an upper spring seat 34 which is affixed to the vehicle frame/chassis 24. Accordingly, the vehicle weight is transferred from the frame 24, through the air springs 32, to the axle 12, and to the ground engaging wheels (not shown).

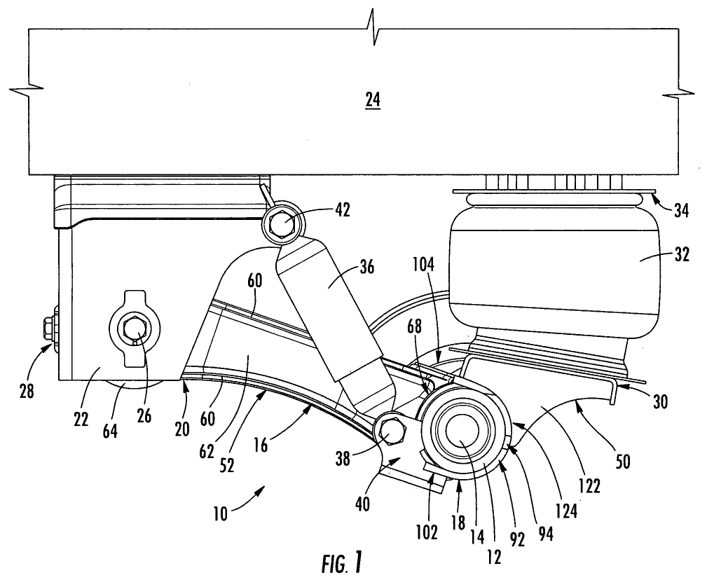

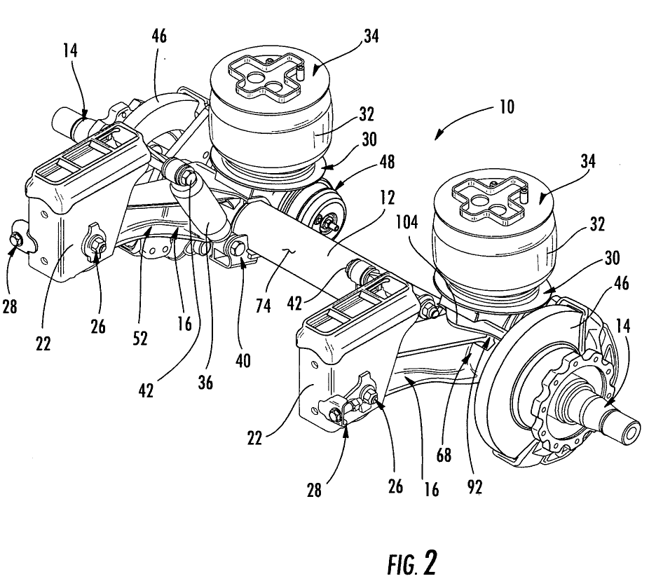

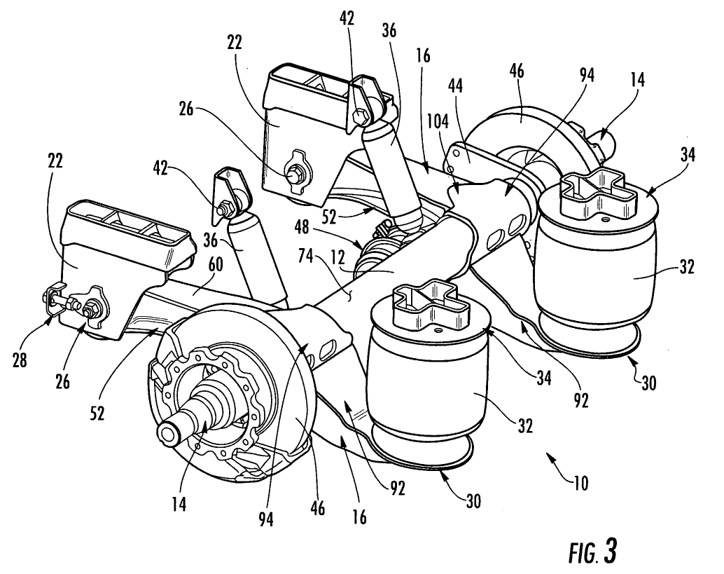

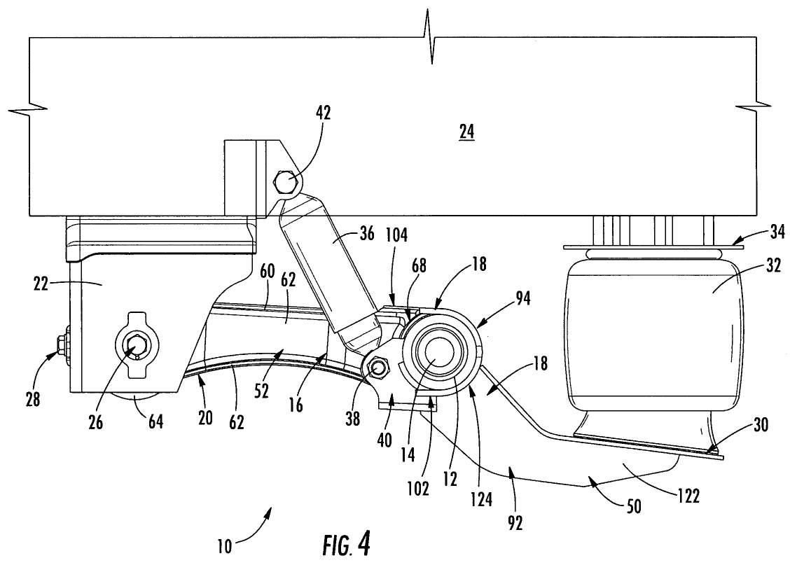

Shock absorbers 36 are provided and are pivotally secured at their lower ends with a bolt 38 to a shock absorber bracket 40. Shock absorber bracket 40 is affixed to the trailing arm 16 at the rearward end 18 thereof as more fully described hereinbelow. At its upper end, shock absorber 36 is pivotally secured with a bolt 42 to the hanger bracket 22 as shown in the embodiment of FIGS. 1 and 2, or to the vehicle frame 24 as shown in the embodiment of FIGS. 3 and 4.

The trailing arm suspension system 10 further includes brake components including a brake spider 44 affixed to the exterior of the axle 12, disks 46 affixed to the axle spindles 14, brake actuation mechanisms 48, etc. for selectively stopping the vehicle in a known and customary manner.

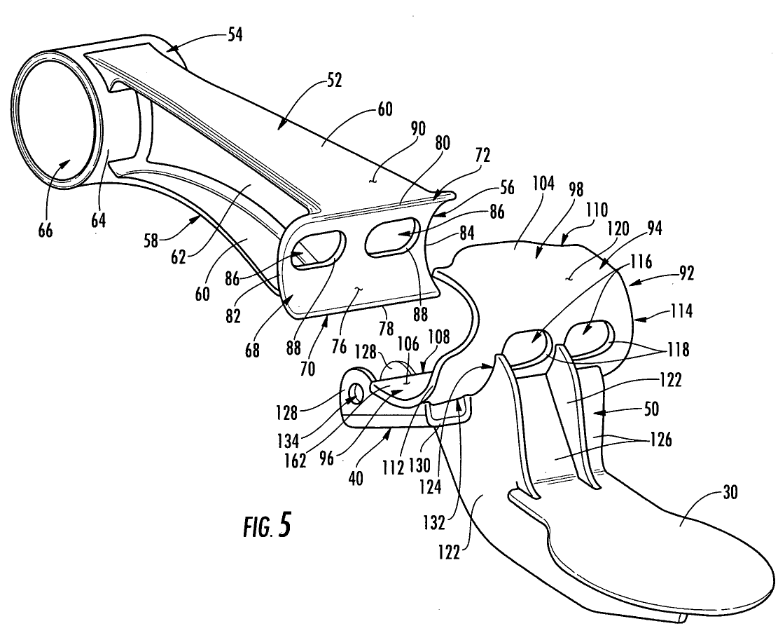

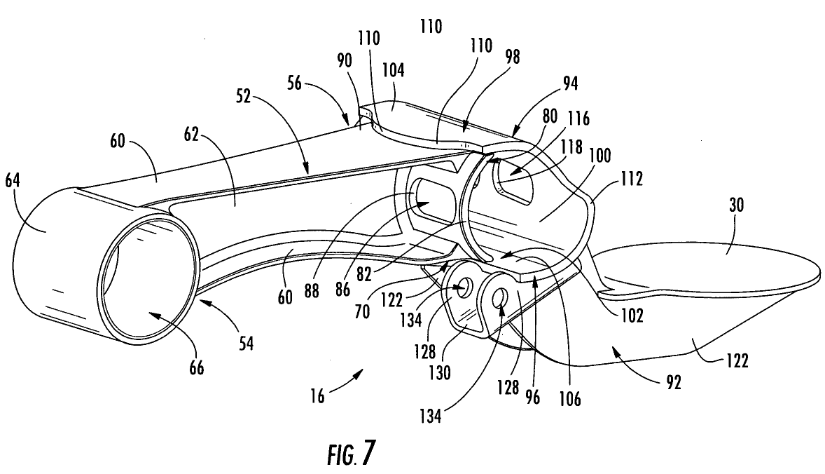

Referring now, more particularly, to FIGS. 5-8, a trailing arm and a trailing arm to axle securement assembly constructed in accordance with the principles of the present invention is shown and described. It is noted that in the embodiment shown in FIGS. 5-8, the spring seat 30 is mounted to the trailing arm 16 with a bracket 50 such that the spring seat 30 is located generally vertically below the axle axis of rotation or in an “underslung” configuration. This underslung configuration is also shown in FIGS. 3 and 4. In the embodiment shown in FIGS. 1 and 2 the spring seat 30 is mounted to the trailing arm 16 with a bracket 50 such that the spring seat 30 is located generally vertically above the axle axis of rotation or in an “overslung” configuration.

The trailing arms 16, in accordance with the principles of the present invention, include a pivot arm component 52 having a first end 54 adapted to be pivotally secured to the hanger bracket 22, and includes a second end 56 adapted to be rigidly affixed to the axle 12. Pivot arm component 52 is preferably made of metal by casting into the shape as shown and described herein. Pivot arm component 52 includes a central portion 58 located between the first end 54 and the second end 56 which has an I-beam cross sectional shape comprising upper and lower generally horizontally situated flange portions 60. A generally vertically situated web portion 62 located centrally between the flange portions 60. The flange and web portions 60, 62 are integrally formed together during the casting process. The size and thickness of the flange and web portions 60, 62 may be varied as needed for providing the necessary structural stability and strength of the trailing arm.

A cylindrical member 64 is provided at the pivot arm component first end 54 and is also integrally formed with the central portion 58 when casting. Cylindrical member 64 includes a bore 66 adapted to receive a bushing (not shown). Pivot bolt 26 is received through the central axis of the bushing within the bore 66 for pivotally securing the first end 54 of the pivot arm component 52 to the hanger bracket 22.

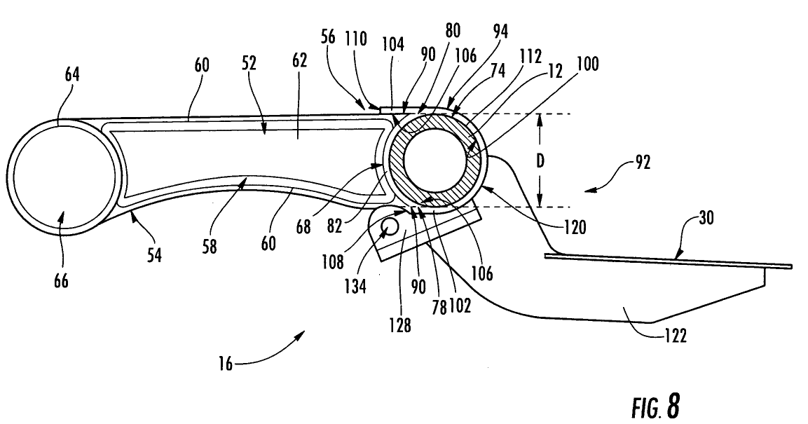

A first axle engagement or saddle portion 68 is provided at the second end 56 of the pivot arm component 52 and is also integrally formed therewith when casting. First axle engagement portion 68 includes first and second terminal ends 70, 72 which, as best seen in FIG. 8, are located a distance from one another which is about equal to or no greater than the outer diameter D of the axle 12.

More particularly, when the outer surface 74 of axle 12 is cylindrically shaped as shown, the first axle engagement portion 68 is semicircular shaped including a semicircular shaped axle engagement surface 76. The axle engagement surface 76 is shaped having a diameter substantially similar to diameter D and having an arc length of less than 180°. The first axle engagement portion 68 thereby includes, at the perimeter of the semicircular axle engagement surface 76; first and second longitudinal edges 78, 80 and first and second semicircular edges 82, 84. As best seen in FIG. 8, the first and second longitudinal edges 78, 80 are apart from one another a distance of about or less than the diameter D, and so the first and second semicircular edges 82, 84, along with the axle engagement surface 76, circumscribe the axle exterior surface 74 a distance less than about 180°.

A pair of openings 86 are provided and extend through the first axle engagement portion 68, one on each side of the central web portion 62. Openings 86 define opening edges 88.

The first axle engagement portion 68 has a thickness sufficient for the purpose of being rigidly secured by welding to the axle exterior surface 74 and transferring the loads therefrom to the trailing arm 16. The thickness of the first axle engagement portion 68 is also sufficient such that, when the first axle engagement portion 68 is placed in abutting relation against the axle exterior surface 74, the first axle engagement portion 68 may be rigidly affixed to the axle exterior surface 74 by welding thereon along any one or all of the first and second longitudinal edges 78, 80, first and second semicircular edges 82, 84 and the openings edges 88.

As best seen in FIGS. 5 and 8, the flange portions 62 near the first and second longitudinal edges 78, 80 are provided with exterior flat surfaces 90. Flat surfaces 90 are generally parallel to one another and are located in planes which are tangent to the axle exterior surface 74 and at a distance from one another of about or less than a distance equal to the diameter D.

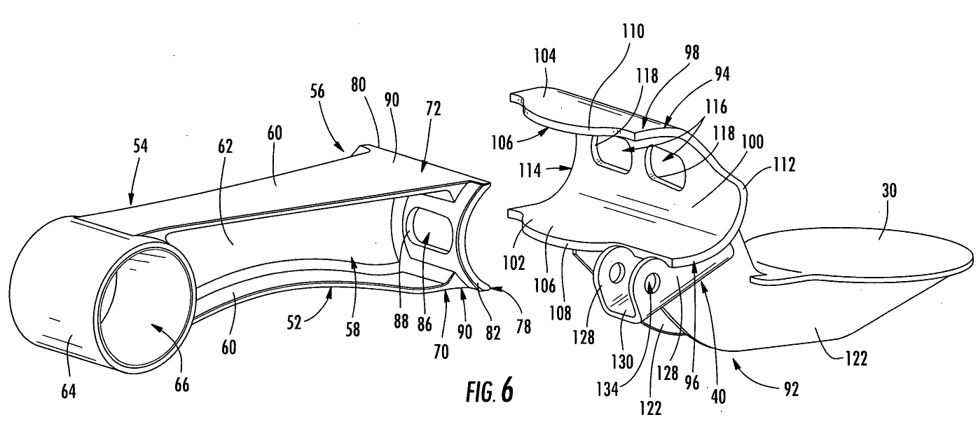

The trailing arm 16 further comprises a tail component 92 having a second axle engagement or saddle portion 94. The second axle engagement portion 94 is provided with first and second terminal ends 96, 98. The second axle engagement portion includes an axle engagement surface 100 which is semicircular shaped having a diameter of about or slightly larger than the distance D. Overlapping portions 102, 104 are provided at each of the first and second terminal ends 96, 98. As best seen in FIGS. 6 and 8, the axle engagement surface 100 is semicircular shaped extending along an arc of about 180°, and the overlapping portions 102, 104 extend therefrom at each of the first and second terminal ends 96, 98 over the first axle engagement portion 68 of the pivot arm component 52. The overlapping portions 102, 104 are generally parallel to one another and include flat surfaces 106 which are parallel to one another and are located in planes which are tangent to the axle exterior surface 74 and at a distance from one another equal to or slightly greater than the distance D. Flat surfaces 106 of the overlapping portions 102, 104 are slidingly received over the flat surfaces 90 of the pivot arm component 52 when the second axle engagement portion 94 is placed in abutting relation to the axle exterior surface 74 as shown in FIG. 8.

The second axle engagement portion 94 is made of metal having a thickness similar to the thickness of the first axle engagement portion 68 thereby defining, along the perimeter of the semicircular axle engagement surface 100, first and second longitudinal edges 108, 110 and semicircular edges 112, 114. Openings 116 are provided through the second axle engagement portion 94 and define openings edges 118.

As best seen in FIGS. 1-4 and 8, the second axle engagement portion 94 is affixed to the axle 12 and to the pivot arm component 52 by placing the second axle engagement portion 94 against or in abutting relation to the axle with the axle engagement surface 100 thereof against the axle exterior surface 74 and with the overlapping portions 102, 104 thereof over the flat surfaces 90 of the pivot arm component 52. In this position, the second axle engagement portion 94 is rigidly secured by welding along longitudinal edges 108, 110 to the flat surfaces 90 of the pivot arm component 52 and welding along the semicircular edges 112, 114 and the openings edges 118 to the axle exterior surface 74.

When affixing the pivot arm component 52 and the tail component 92 to the axle 12, the first axle engagement portion 68 of the pivot arm component 52 is placed in abutting relation to the axle with the axle engagement surface 76 thereof in abutting relation to the axle exterior surface 74. The tail component 92 is placed in abutting relation to the axle with the axle engagement surface 100 thereof adjacent or in abutting relation to the axle exterior surface 74 thereby also placing the first terminal end 70 adjacent the first terminal end 96, and the second terminal end 72 adjacent the second terminal end 98 or, more particularly, with the overlapping portions 102, 104 extending over the terminal ends 70, 72 of the pivot arm component 52. With the pivot arm component 52 and the tail component 92 in this position, the first terminal ends 70, 96 and the second terminal ends 72, 98 are welded to one another as described more fully hereinabove at least along longitudinal edges 108, 110; and the first axle engagement portion 68 and/or the second axle engagement portion 94 are welded to the axle exterior surface 74 along semicircular edges 82, 84, 112, 114 and the openings edges 88, 118. As should now be appreciated, the trailing arm 16 is thereby formed and is thereby reliably secured to the axle so that the trailing arm to axle assembly is capable of withstanding relatively severe forces as may be experienced by the vehicle.

In an alternate more preferred assembly method, the pivot arm component 52 is first placed in abutting relation to the axle and is first welded thereto at least along the first and second longitudinal edges 78, 80. Thereafter, the tail component 92 is placed in abutting relation to the axle with the overlapping portions 102, 104 extending over the previously applied weld beads between the first and second longitudinal edges 78, 80 and the axle exterior surface 74. Then, the first axle engagement portion 68 and the second axle engagement portion 94 are welded to one another along longitudinal edges 108, 110, and to the axle as described hereinabove along semicircular edges 82, 84, 112, 114 and the openings edges 88, 118.

As described hereinabove, the tail component 92 is made of metal and, preferably, is made by forming and welding operations. In this regard, the brackets 50 are also made of metal and are secured to the exterior surface 120 of the second axle engagement portion 94 by welding. More particularly, each bracket 50 includes two or more arms 122 made of flat metal/steel and having a semicircular edge 124. Semicircular edge 124 is placed in abutting relation to the exterior surface 120 of the second axle engagement portion 94 and are rigidly welded thereto. Web members 126 may be provided and welded between and/or on the exterior surfaces of the arms 122 for added stability. The spring seats 30 are welded to the arms 122 for receiving thereon the air spring 32. As can be appreciated, the shapes and sizes of the arms 122 and spring seats 30 may be varied as desired for properly locating the air spring 32 such as, for example, in an overslung configuration as shown in FIGS. 1 and 2, an underslung configuration as shown in FIGS. 3-8, and/or some other desired configuration as needed for accommodating the needs of the suspension system and/or particular vehicle.

The shock absorber bracket 40 is similarly made of metal/steel, preferably by a forming operation, and affixing to the tail component 92 by welding. More particularly, the shock absorber bracket 40 is preferably made by stamping and bending a metal plate into a U-shape comprising a pair of parallel walls 128 which are joined with a central wall 130. Parallel walls 128 are provided with a semicircular shaped edges 132 adapted to abut the outer surface 120 of the second axle engagement portion 94. The shock absorber bracket 40 is thereby affixed to the second axle engagement portion 94 of the tail component 92 by welding along the semicircular edges 132 and the exterior surface 120. Holes 134 are provided through the parallel walls 128 which are adapted to receive the bolt 38 for pivotally securing thereto the shock absorber 36.

1-19. (canceled)

20. A vehicle suspension trailing arm for pivotally securing an axle to a vehicle frame, said trailing arm comprising:
a pivot arm component having a first end adapted for pivotal securement to the vehicle frame and a second end comprising a first axle engagement portion, said axle engagement portion having first and second terminal ends;
a tail component having a second axle engagement portion, said second axle engagement portion having first and second terminal ends;
wherein said first and second axle engagement portions are adapted to abut and together circumscribe the axle, and wherein said first terminal ends of said first and second axle engagement portions are affixed to one another and said second terminal ends of said first and second axle engagement portions are affixed to one another; and,
wherein said pivot arm component is made of metal by casting.

21. The trailing arm of claim 20 wherein at least one of said first and second axle engagement portions includes an opening defining an opening edge, whereby said at least one of said first and second axles engagement portions may be affixed to the axle by welding.

22. The trailing arm of claim 20 wherein said first terminal ends of said first and second axle engagement portions overlap and are affixed to one another by welding, and said second terminal ends of said first and second axle engagement portions overlap and are affixed to one another by welding.

23. The trailing arm of claim 20 wherein said first terminal ends of said first and second axle engagement portions are affixed to one another by welding and said second terminal ends of said first and second axle engagement portions are affixed to one another by welding and wherein said at least one of said first and second axle engagement portions is affixed to the axle by welding.

24. The trailing arm of claim 20 wherein said pivot arm component includes a central portion having an I-beam cross-sectional shape.

25. The trailing arm of claim 20 further comprising a spring seat affixed to said tail component adapted to receive a spring thereon.

26. The trailing arm of claim 20 wherein one of said first and second axle engagement portions circumscribe the axle less than 180 degrees and the other of said first and second axle engagement portions circumscribe the axle at least 180 degrees and includes overlapping portions at its first and second terminal ends extending over and being affixed to the axle engagement portion of less than 180 degrees.

27. The trailing arm of claim 20 wherein said first engagement portion is semicircular shaped and is adapted to circumscribe the axle less than 180 degrees and said second axle engagement portion is semicircular shaped and is adapted to circumscribe the axle at least 180 degrees, said second axle engagement portion having overlapping potions at its first and second terminal ends extending over and being affixed by welding to said first engagement portion.

28. The trailer arm of claim 20 wherein said first engagement semicircular portion and said second engagement semicircular portion each include an opening defining an opening edge whereat said engagement portions may be affixed to the axle by welding; wherein said pivot arm component includes a central portion having an I-beam cross-sectional shape; a spring seat is affixed to said tail component; and, a shock absorber bracket is affixed to said tail component.

29. The trailing arm of claim 20 further comprising a shock absorber bracket-affixed to said tail component whereat a shock absorber may be pivotally secured thereto.

30. In a vehicle suspension, a method of securing an axle to a trailing arm wherein said trailing arm comprises a pivot arm component having a first end adapted for pivotal securement to the vehicle frame and a second end comprising a first axle engagement portion, said axle engagement portion having first and second terminal ends; a tail component having a second axle engagement portion, said second axle engagement portion having first and second terminal ends and, wherein said first and second axle engagement portions are adapted to abut and together circumscribe the axle, said method comprising the steps of:
placing said first and second axle engagement portions in abutting relation to the axle with said first terminal ends of said first and second axle engagement portions adjacent one another and said second terminal ends of said first and second axle engagement portions adjacent one another whereby said axle engagement portions together circumscribe the axle; and,
welding said first terminal ends to one another, said second terminal ends to one another and at least one of said first and second axle engagement portions to the axle.

31. The method of securing an axle to a trailing arm of claim 30 wherein said first terminal ends of said first and second axle engagement portions overlap one another and said second terminal ends of said first and second axle engagement portions overlap one another, and wherein during the step of welding said terminal ends are welded at said overlaps.

32. The method of securing an axle to a trailing arm of claim 30 wherein, during the step of welding, at least one of said first terminal ends and said second terminal ends of said axle engagement portions are welded to the axle.

33. The method of securing an axle to a trailing arm of claim 30 wherein at least one of said first and second axle engagement portions include an opening defining an opening edge and wherein, during the step of welding, said opening edge is welded to the axle.

34. The method of securing an axle to a trailing arm of claim 30 further comprising the step of making said pivot arm component of metal by casting.

35. The method of securing an axle to a trailing arm of claim 30 further comprising the step of affixing a spring seat to said tail component by welding.

36. The method of securing an axle to a trailing arm of claim 30 wherein one of said first and second axle engagement portions is less than 180° and during the step of placing abuts the axle less than 180°, and the other of said first and second axle engagement portions is at least 180° and during the step of placing abuts the axle at least 180°.

37. The method of securing an axle to a trailing arm of claim 36 wherein said axle engagement portions of at least 180° includes overlapping portions at its first and second terminal ends and wherein, during the step of placing, said overlapping portions extend over said axle engagement portion of less than 180° and are welded thereto.

38. The method of securing an axle to a trailing arm of claim 30 wherein said axle is circular shaped in cross section and said first engagement portion is semicircular shaped, wherein during the step of placing said first engagement portion circumscribes the axle less than 180°, and wherein said second axle engagement portion is semicircular shaped and is at least 180°, and wherein during the step of placing said second axle engagement portion circumscribes the axle at least 180°.

39. The method of securing an axle to a trailing arm of claim 38 wherein said second axle engagement portion includes overlapping portions at its first and second terminal ends and wherein said overlapping portions extend over and are affixed to said first engagement portion by welding.

40. The method of securing an axle to a trailing arm of claim 30 further comprising the step of affixing a shock absorber bracket to said tail component by welding.

41. A vehicle suspension trailing arm for pivotally securing an axle to a vehicle frame, said trailing arm comprising:
a pivot arm component having a first end adapted for pivotal securement to the vehicle frame and a second end comprising a first axle engagement portion, said axle engagement portion having first and second terminal ends;
a tail component having a second axle engagement portion, said second axle engagement portion having first and second terminal ends;
wherein said first and second axle engagement portions are adapted to abut and together circumscribe the axle, and wherein said first terminal ends of said first and second axle engagement portions are affixed to one another and said second terminal ends of said first and second axle engagement portions are affixed to one another; and,
wherein at least one of said first and second axle engagement portions is affixed to the axle.
